(19) United States
(12) Patent Application Publication
(10) Pub. No.: US 2023/0177488 A1
(43) Pub. Date: Jun. 8, 2023

(54) ELECTRONIC MONEY BOX

(71) Applicant: Maayan Zahav, Shaarey Tikva (IL)

(72) Inventor: Maayan Zahav, Shaarey Tikva (IL)

(21) Appl. No.: 17/993,890

(22) Filed: Nov. 24, 2022

Related U.S. Application Data
(60) Provisional application No. 63/286,137, filed on Dec. 6, 2021.

(51) Int. Cl. G06Q 20/36; G07D 11/00

(52) U.S. Cl. CPC G06Q 20/367; G07D 11/0093

(57) ABSTRACT

A device and system for an electronic savings box for receiving money (e.g., donations, savings, etc.) and/or reporting the amount of money contained therein for the purpose of donating charity and/or saving money and/or investing and/or transferring funds.

### RELATED APPLICATION/S

This application claims the benefit of priority under 35 USC § 119(e) of U.S. Provisional Patent Application No. 63/286,137 filed 6 Dec. 2021, the contents of which are incorporated herein by reference in their entirety.

### TECHNICAL FIELD

The present invention, in some embodiments thereof, relates to an electronic money box and, more particularly, but not exclusively which may be designed for the purpose of donating charity and/or saving money and/or investing and/or transferring funds.

### BACKGROUND

Savings boxes, such as piggy banks, charity boxes, etc., have been around for centuries. Generally, a savings box is sealed and the amount of money in the savings box is not known until after the money box is opened. Often, unsealing a savings box damages the money box beyond repair for further use. Electronic savings boxes which count the money inserted require bill/coin recognizing hardware and/or software, which may be expensive. Therefore, such systems are not in wide distribution in homes and/or shops.

US Patent Publication no. 2008/0006649 appears to disclose, “An apparatus and method for promoting voluntary contributions, such as to charitable causes, in association with an automated merchandising machine. The apparatus comprises a collection container with a lockable access door, the container adapted for mounting to an automated merchandising machine.”

US Patent Publication no. 2008/0033855 appears to disclose, “The invention can also serve to promote or distribute goodwill (e.g., the promotion of a sponsor's goodwill and/or the distribution to those in need). An electronic apparatus, hereinafter a donation station (also referred to as “The Charity Box”) facilitates a user in making a charitable donation.”

U.S. Pat. No. 10,080,410 appears to disclose, “A charity box device, wherein the display shows: a. the daily total of charitable acts for the charity box device; b. the lifetime total of charitable acts for the charity box device; c. the daily total of charitable acts for all the charity box devices connected to the database.”

US Patent Publication no. 2016/0247131 appears to disclose, “a charity box or digital donation box is based on a donation or charity box or kiosk. And when a customer or user finds a charity box to give left over change the user has few available options.”

Additional background art includes U.S. Pat. Nos. 8,672,134, 10,842,195, 8,863,256, US Patent Publication no. 2020/039766, US Patent Publication no. 2015/0351456, U.S. Pat. No. 10,887,125, US Patent Publication no. 2019/0163876.

Therefore, there is a need for an electronic savings box for receiving money (e.g., donations, savings, etc.) and/or reporting the amount of money contained therein for the purpose of donating charity and/or saving money and/or investing and/or transferring funds.

### SUMMARY

According to an aspect of some embodiments of the invention, there is provided an electronic money box including: a cash depository within a housing of the box including a money insertion slot leading from outside the housing into the cash depository; a processor configured for identifying cash deposits to the depository, recording cash deposits and non-cash contributions, reporting an amount of money in the depository, and reporting an amount of money owed to a recipient of the cash contributions and the non-cash contributions; a user input interface including a quick control for donating a predetermined non-cash contribution; and an output interface configured to report to a user: the cash deposits, the non-cash contributions, the amount of money in the depository and the amount of money owed to a recipient of the cash contributions and the non-cash contributions.

According to some embodiments of the invention, the electronic money box further includes a child proof system.

According to some embodiments of the invention, the quick control includes a child proof protection.

According to some embodiments of the invention, the housing further includes a network connection and wherein the processor is configured to execute and record a monetary transaction.

According to some embodiments of the invention, the electronic money box is connected to at least one of a financial institution, a monetary account of a charity and an a monetary account of an individual, through a network.

According to some embodiments of the invention, the network includes at least one of an internet, a cellular network, satellite network, LAN, Wi-fi, and Bluetooth.

According to some embodiments of the invention, the quick control includes a button.

According to some embodiments of the invention, at least one control button is configured to provide at least one specific function.

According to some embodiments of the invention, the input interface includes at least one of a keyboard, a touch screen, at least one control button, and a mobile application running on a personal computing device of the user.

According to some embodiments of the invention, the input interface and the output interface include a shared touch screen.

According to some embodiments of the invention, the processor is connected to a mobile application.

According to some embodiments of the invention, the cash depository includes a locking mechanism.

According to an aspect of some embodiments of the invention, there is provided a method for using an electronic money box, the method including: depositing cash to the electronic money box by inserting money through a money slot into a depository; depositing a predetermined non-cash deposit by activating a quick control; recording the non-cash deposit in an electronic database.

According to some embodiments of the invention, the method further includes recording the cash deposit in the electronic database.

According to some embodiments of the invention, the method further includes detecting a value of the cash deposit via an electronic sensor.

According to some embodiments of the invention, the method further includes reporting a value of the cash via a user input interface.

According to some embodiments of the invention, the method further includes depositing a non-cash deposit by charging a credit card or financial mobile application.

According to some embodiments of the invention, the method further includes depositing a non-cash deposit by inputting a user selected amount of money through a user input interface.

According to some embodiments of the invention, the method further includes displaying a total amount of money received by the electronic money box.

According to some embodiments of the invention, the electronic money box includes a network interface and further including electronically transferring money to a recipient via the network interface and updating the electronic database in accordance with the money electronically transferred.

According to some embodiments of the invention, the method further includes enabling the quick control by releasing a child proofing mechanism.

According to some embodiments of the invention, the method enabling the quick control by releasing a child proofing mechanism.

According to some embodiments of the invention, the method enables the non-cash deposit by releasing a child proofing mechanism.

According to some embodiments of the invention, the transferring occurs when a pre-determined threshold amount is reached.

According to some embodiments of the invention, the method further includes confirming completion of transfer of the money to a recipient.

According to some embodiments of the invention, the displaying is initiated by a user.

According to some embodiments of the invention, the displaying is initiated remotely by a recipient or representative thereof.

According to some embodiments of the invention, the method further includes reporting to a recipient when a pre-determined threshold amount is reached.

According to some embodiments of the invention, the method further includes collecting an amount of money from an electronic money box.

According to some embodiments of the invention, the collecting occurs when a pre-determined threshold amount is reached.

### DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the figures:

FIG. 1: A schematic diagram illustrating an optional embodiment of the current invention.

FIG. 2: A block diagram illustrating an embodiment of the current invention.

FIG. 3: A flow chart illustrating a method in accordance with an optional embodiment of the current invention.

FIG. 4: A flow chart illustrating a method in accordance with an optional embodiment of the current invention.

### DESCRIPTION OF SPECIFIC EMBODIMENTS

The present invention, in some embodiments thereof, relates to an electronic money box and, more particularly, but not exclusively which may be designed for the purpose of donating charity and/or saving money and/or investing and/or transferring funds.

### Overview

An aspect of some embodiments of the current invention relates to an electronic money box is disclosed and described. Optionally, the electronic money box may be designed for the purpose of giving charity and/or saving money and/or investing and/or transferring funds.

An embodiment of the current invention may be an electronic money box which may have various functions. Some embodiments may be designed for giving charity and/or for saving money and/or for paying for things and/or other transfers of money. According to some embodiments, the electronic money box may be a charity box, savings box, piggy bank, safe, etc. The system may include a depository for cash and/or promissory notes. For example, there may be a deposit slot to the depository. Optionally, the depository includes an enclosed space and/or a deposit slot configured to facilitate depositing items while inhibiting their removal and/or a locked access passage (e.g., a locked door) for removing contents. For example, the lock may be mechanical (e.g., opened via a key and/or combination). Alternatively or additionally, the lock may be opened by biometric identification and/or via an application on an predesignated secondary device (e.g., a cellular phone).

According to some embodiments, the electronic money box may be a charity box. Optionally, the charity box may be a personal charity box. Optionally, a user who owns the charity box, and/or the location of the charity box (e.g., house, shop, office, etc.) may select what to do with the money. Optionally, the charity box may be a dedicated charity box e.g., distributed and/or collected by a particular charity, wherein the money goes to that particular charity. Optionally, there may be a division of control between people who donate, and/or the charity and/or the owner of the location and/or charity box. Optionally, a donor may specify through a user interface to whom their money should be directed (e.g., the charity box may include a few choices of charities). Optionally, a donor may specify a recipient for their donation.

According to some embodiments, the electronic money box may include a safe and a housing. Optionally, the housing may include a slot for putting in money. Alternatively, and/or additionally, the electronic money box may include a screen e.g., to show user input, to receive user input, to display data. Optionally, the screen may show a user the status of the contents of the electronic money box. Optionally, the screen may be a touch screen. Optionally, the electronic money may include one or more buttons to perform various functions. Optionally, the electronic money box may include a processor. Optionally, the processor that may keep track of how much money is in the box. Optionally, the processor may include a connection to an external network such as the internet, a cellular network, satellite network, LAN, Wi-fi, Bluetooth, etc. or a combination thereof. Optionally, the electronic money box may connect to a mobile application that may work in conjunction with the box. Alternatively, and/or additionally, there may be a means (e.g., a mobile application) for users (e.g., donors, owners, users, collectors, etc.) to monitor the status of the contents of the electronic money box.

According to some embodiments, the electronic money box may include an input interface. Optionally, a user may use the input interface to tell the electronic money box the value of the money that is being donated. Advantageously, instead of expensive bill/coin recognizing hardware, a user may insert money through a slot and/or credit card reader and/or financial mobile application. Optionally, a user may input through the input interface the amount of money inserted into the electronic money box. Optionally, the input interface may be a native interface. Optionally, the input interface may be a mobile application, e.g., a donor's cellular phone may be in communication with an electronic money box wirelessly (e.g., through a cellular network, satellite network, Wi-Fi, Bluetooth, etc.).

According to some embodiments, the electronic money box (e.g., a charity box) that may have a dual functionality. Optionally, an electronic money box may be designed to collect coins/bills and/or charge a credit card and/or charge a financial mobile application. Optionally, the electronic money box may allocate the collected funds directly to a recipient e.g., charity, financial institution, third party, etc. Optionally, the electronic money box may return coins/bill and/or change.

According to some embodiments, an electronic money box may be programmed to allow one touch billing of a contribution by a credit card. Optionally, the one touch charging may include a child proof feature, for example two buttons that must be pressed simultaneously to make the charge.

According to some embodiments, the electronic money box may include a quick control (e.g., control button with pre-programmed functionality) to easily donate a pre-determined donation. Optionally, the electronic money box may include child proofing for the quick control.

According to some embodiments, child proofing the electronic money box may include activating a feature of the electronic money box (i.e., electronic donation, etc.) which may Optionally, require simultaneously pushing two buttons distant from each other and/or another action which might be difficult for a child perform. Optionally, at least one of the buttons may be on a top surface (e.g., so that the force of pushing the buttons may be transferred to the surface on which the electronic money box sits such as since the electronic money box may not be very heavy, if a button on the side of the electronic money box pushing the button may push the electronic money box across the surface).

Alternatively, and/or additionally, a button may require a large surface to touch it (e.g., a child's finger may be too small), such as a capacitive button etc. Optionally, a passcode may be required. Optionally, a specific series of actions may be taken, such as buttons must be pushed, a button may be required to be turned and then pressed and/or other functions that a child may not know about and/or may not be able to do. Optionally, the electronic money box may provide a list of instructions which must be carried out which the child may not be able to read. Alternatively or additionally, there may be two or more buttons that need to be pushed (e.g., simultaneously) optionally the buttons are distanced in a way which would be difficult for a child to push simultaneously (e.g., due to the distance between them) and/or buttons may need to be pressed in a particular sequence and/or combination that would be difficult to perform without being told the combination.

According to some embodiments, the electronic money box may include one or more programmable sounds which may automatically play and/or may be controlled remotely (e.g., by the user and/or the charity), for example, a rewarding sound may be played when money is inserted, etc.

There are various challenges that may occur in collecting charity boxes. A recipient representative (e.g., charity collector) may not know how much money is in the charity box and/or on some occasions a charity collector may go out of their way and/or use their time and/or resources to collect the charity box which may not have much money in it. In such a case seemingly, it would have been more worth the charity collector's time to collect a charity box form an alternative location and/or do something else more worthwhile for the charity organization. For example, an organization may pay a charity collector 10 dollars per hour. One day the charity collector goes to collect a charity box from a supporter, but it takes him 2 hours to get to the supporter and/or when he comes to the supporter, he finds only 10 dollars in the charity box. In such a case it would not have been worth the expense.

Alternatively, and/or additionally, according to some embodiments, a recipient representative (e.g., a charity collector, etc.) may wish to have an efficient way to collect money and/or communicating with the donors on the status of the money they set aside. According to some embodiments, the money box may include a display on which the amount of money entered, transferred thereto and/or contained within may be shown. Optionally, the total amount of money may be displayed upon a command from a user. For example, a charity and/or an organization may supply supporters with a charity box which they may keep in their house and/or office and/or shop, etc. and an organization may from time to time come to collect the money that has accumulated in the charity box.

According to some embodiments, the amount of money in the charity box could advantageously be displayed. Optionally, the total amount of money in the charity box may be displayed on command. Optionally, the amount of money may be reported to a charity collector prior to their arrival on-site, e.g., to prevent waste of time and/or resources. Optionally, the status of the charity box may be checked remotely e.g., a charity collector may remotely check how much money is the box, etc. Optionally, once a pre-determined threshold amount is met, a report may be sent to a charity collector, e.g., to come and collect the money. Optionally, the report may be made by the user e.g., a user may check the total of money in the charity box daily, weekly, monthly, etc. Optionally, the electronic charity box may report the total of money in the charity box to the charity collector and/or charity organization through a network, e.g., internet, a cellular network, satellite network, LAN, Wi-fi, Bluetooth, etc., or a combination thereof. Optionally, the electronic charity box may report the total of money in the charity box to the charity collector and/or charity organization automatically after a pre-determined period, e.g., daily, weekly, monthly, etc. For example, collection may include the collector and/or charity box notifying the box owner that it is time to pay and/or the box owner may transfer money (e.g., via bank transfer, credit card etc.) to the charity and/or collect any money in the box.

According to some embodiments, a user may wish to, over time, accumulate money and/or then transfer the accumulated funds to a recipient, e.g., a person and/or an organization and/or a bank account and/or an investment. etc. For example, a user may wish to accumulate a few coins each day and/or a few bills each day, such as their small change, tips, a fixed amount, left over monies from a budgeted amount, money earned, etc.

In some embodiments, a box may be used to track money between different accounts and/or organizations. For example, a user may put money in the box and/or transfer money via the user interface between his account and that of a charity and/or a family member. Optionally, the user may be identified by the device. For example, the user may be identified by a passcode and/or by a biometric device and/or the user may use a personal computing device to identify himself. Optionally, the box may store money and/or automatically make transfers and/or periodically make transfers and/or periodically tell a user to make a transfer and/or notify a user when money is credited to him and/or debited. In some embodiments the box and/or associated application may keep track of who owes what to whom without actually transferring funds. Additionally or alternatively, the box, user interface and/or application may supply a convenient interface to get money and/or transfer money according to the recorded accounts. For example, the box may serve as a group bank and/or a way for a group to track and transfer money. For example, a family may keep money in a single account and/or keep track of the money and/or access it via the box and/or associated applicaiton. In some embodiments, the box and/or application may be used remotely (e.g., by a user over his personal computing device [e.g., smartphone, tablet, personal computer etc.]). For example, the box may be used to encourage children to save money. For example, a parent may keep track of how much money a child has deposited and/or give to the child encouragement. Optionally, the child may make deposits and/or withdrawals. Optionally, the parents will control and/or be notified of activities (e.g., deposits/withdrawals). Thus, the box may be used as an educational device to help train children to handle money properly and/or responsibly.

Alternatively, and/or additionally, according to some embodiments, a user may wish to save money over time and/or to monitor the contents of the savings box. Optionally, a user may wish to have a transfer system for transfer of funds once money has accumulated in the savings box. Optionally, a user may wish to invest the money accumulated in the savings box. For example, a user may wish to invest extra money in a trust fund and/or a stock and/or from time to time, a user may set aside money for this. Optionally, the savings box may be configured to communicate with an external financial service provider, e.g., over a network such as the internet, a cellular network, satellite network, LAN, Wi-fi, Bluetooth, etc., or a combination thereof.

Alternatively, and/or additionally, according to some embodiments, a user may wish to save money in a safe. Optionally, a user may put money into the safe, which may keep a record of the amount saved. Optionally, a user may transfer an amount of money to a safe virtually. Optionally, the virtual amount of money may be transferred to a user's bank account. Optionally, the virtual amount of money may be transferred may be transferred over a network such as the internet, a cellular network, satellite network, LAN, Wi-fi, Bluetooth, etc. or a combination thereof. For example, a child may wish to save their pocket money in a piggy bank. The child's parent may then take the money out of the piggy bank and transfer the saved amount to a bank account. The piggy bank may keep a record of the amount of money saved and/or transferred.

### Specific Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Reference is now made to the figures.

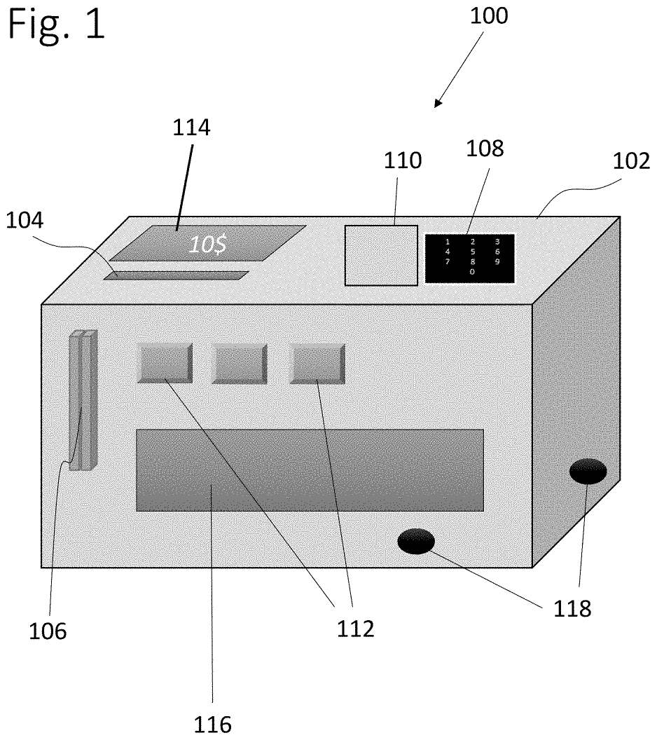

FIG. 1 is a schematic diagram illustrating an optional embodiment of the current invention. For example, the electronic money box 100 may include a housing 102 and a safe (not shown). The housing may include one or more money slots 104, credit card reader 106 and/or additional money insertion or transfer sites. The housing may include one or more user input interfaces, such as a keyboard 108, touch screen 110, control buttons 112, etc. Optionally, the housing may also include a contents screen 114 (may be the touch screen and/or be a display screen) and an electronic money box opening 116, through which the safe may be accessed. Optionally, a child proof feature, such as child safety buttons 118 may be included. For example, a quick contribution may be disabled until the child safety buttons 118 are properly pushed. The child may not know that he needs to push the buttons in a particular order and/or simultaneously and/or a switch may be configured such that it would be difficult (e.g., due to the size of his hand and/or finger and/or the strength of his grip etc.) for a child to activate. For example, two buttons may be positioned far apart that it would difficult to push them together with a small and and/or positioned where it is difficult to get two hands together. Alternatively or additionally, when a donation is made, the box may notify a mobile device of the user for approval. The transaction may be prevented until the user approves on his own device. Alternatively or additionally, user may know what was deposited and when and whether it was approved and/or may inhibit further donation.s

According to some embodiments, the electronic money box may include a housing and/or a safe. Optionally, the housing and/or safe may be of various sizes. Optionally, a housing and/or a safe may range in size from between about 0.1 to about 1 liter of space, and/or between about 1 to about 10 liters of space, and/or between about 10 to about 100 liters of space, etc. Each possibility is a separate embodiment.

According to some embodiments, the electronic money box may include a slot that may be designed for inserting money. Optionally, the electronic money box may include an opening which may be designed to insert and/or remove money from the electronic money box. Optionally, an opening in the electronic money box may include a locking system.

According to some embodiments, the electronic money box may include a processor, which may have a function and/or various functions. Optionally, the processor may keep a record of various status details, for example, how much total money is in the electronic money box, history of money inserted into the electronic money box, what coins and/or bills and/or checks are inside the electronic money box, how much of each currency, etc. Optionally, the processor may include a record of the donors and/or the amount donated by each donor.

According to some embodiments, the electronic money box may include a screen that may present to a user various detail about the contents of electronic money box, for example, how much total money is in the electronic money box, history of money inserted into the electronic money box, what coins and/or bills and/or checks are inside the electronic money box, how much of each currency, etc.

According to some embodiments, the electronic money box may include a coin and/or bill and/or check detection function. Optionally, the detection function and/or device may be preset for a certain country and/or multiple countries' currency and/or a user and/or a technician may program the software to identify various currencies. Optionally, the electronic money box may detect the diameter and/or width and/or weight of a coin. For example, the processor may be programed to recognize when a coin of that size is inserted, and it may then count it as the desired coin. Optionally, other functions may Optionally, be programmed by the user and/or a technician and/or may be preset. Optionally, there may be an option for a user to manually enter the value of what is inserted into the electronic money box. For example, there may be a keyboard and/or number board buttons that a user may record how much the bills and/or checks and/or coins are and/or there may be a button that corresponds to a certain bill and/or coin and/or on putting money in the electronic money box the user may press the button to inform the system.

According to some embodiments, the electronic money box may include a credit card reader and/or may be connected to a server that may connect to a credit card service. Alternatively, and/or additionally, the system may save credit card details of a user. Optionally, a predetermined quick contribution may be made by means of a electronic payment (e.g., a predetermined quick contribution may be made when a credit card is swiped through a reader and/or upon exposure to a code (e.g., a QR code) of an electronic payment system.

According to some embodiments, the electronic money box may include a passcode and/or a lock. Optionally, the passcode and/or the lock may be required to use some and/or all the functions of the processor. For example, this may help prevent tampering from children. Optionally, some and/or all the functions of the electronic money box and/or processor and/or programing may include a form of tampering proofing (e.g., prevention of child tampering.). Optionally, a quick contribution may be disabled until the child tampering prevention is released. For example, a credit card reader and/or a code reader and/or a quick control may be disabled until the child tampering prevention is released.

According to some embodiments, the electronic money box may include a control button and/or multiple buttons. Optionally, one or more control buttons may be programed for different functions. For example, a control button may be programed such that each time it is pushed and/or pushed in specific way, a certain fixed and/or manually selected amount of money may be billed (e.g., for a credit card and/or bank account etc.) and/or may be scheduled to be billed at a future date. For example, this may enhance ease for a user since the user may not be required to enter physical money and/or scan their credit card, rather the user may just push a button to bill their account automatically.

According to some embodiments, the electronic money box may accept and/or count coins. Optionally, it a coin is not recognized, then it may give a default value and/or list it as an unknown coin (e.g., of a certain size) and/or may ask the donor to specify what it was.

According to some embodiments, the electronic money box may accept bills. Optionally, the money box may not recognize bills (e.g., this may save money on recognition technology). Optionally, the electronic money box may count the bills as a default value and/or the user may be asked to input a value for the bill. For example, a speaker may broadcast an oral request, “please input the value of the inserted bills” and/or the request may appear on a view screen of a user output interface etc.

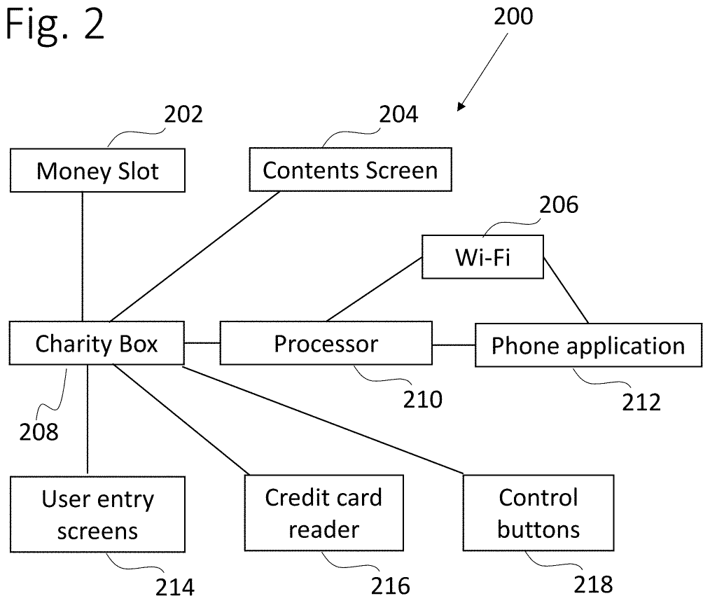

FIG. 2 is a block diagram illustrating an embodiment of the current invention. For example, the electronic money box 200 may be a charity box 208, which may include a money slot 202 and/or one or more user entry screens 214 and/or keyboards, and/or a credit card reader 216 and/or one or more control buttons 218. The charity box 208 may include a processor 210 which may connect by Wi-Fi 206, and/or a user program and/or mobile application 212 and/or a charity collector program. The electronic money box 100 may include a IUT (e.g., a Sim card in in the box)

and/or may use Bluetooth and/or Wi-Fi to connect to an internet server and/or may connect to a mobile device. The electronic money box 100 may include a contents screen 204 which may display the amount of money inserted into the money slot and/or the total amount of money contained within the electronic money box.

According to some embodiments, the electronic money box may include a mobile application and/or program that may be able to monitor the contents of the electronic money box and/or transfer money from the electronic money box and/or open and/or close the electronic money box and/or other controls. For example, an application may be able to show the user the details of the contents of the box, and/or a user may use the application to manually transfer the amount of money in the electronic money box and/or less and/or more to a desired charity and/or person and/or account etc. Once a user has transferred money, they may remove the money from the electronic money box and take it, Optionally, at any time, and/or after a pre-determined time. An application may store the credit card information of the user and/or allow the user to transfer money with reduced clicks and/or the user may select a default charity and/or organization and/or account to which transfer the money etc. Optionally, a user may change settings to whom the money is sent. Optionally, a user may program an automatic transfer scheduled at fixed time interval and/or may schedule a single and/or multiple future transfers. Once a transfer and/or payment is made a user may receive a text message and/or email and/or notification. An application may allow a user to donate remotely from the box.

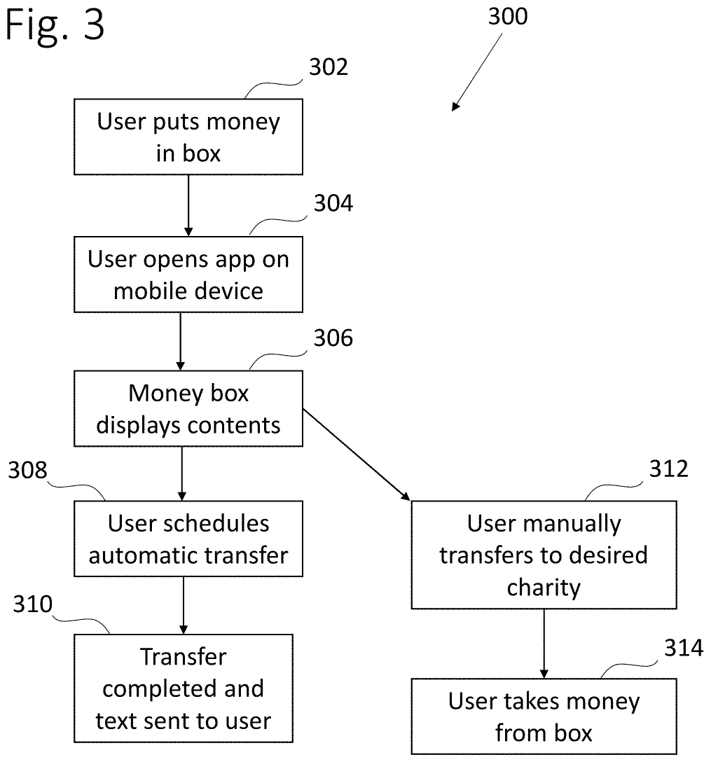

FIG. 3 is a flow chart illustrating a method in accordance with an optional embodiment of the current invention. For example, in a method 300 a user may insert 302 money into an electronic money box. The user may open 304 an app on their mobile device (e.g., cellular phone, tablet, laptop, smart watch, smart glasses, VR, etc.). The money box app and/or housing may display 306 the contents of the electronic money box. A user may then use the app to schedule 308 automatic money transfers to and/or from the electronic money box. Once a transfer is complete, the app may send 310 a text message to the user confirming completion of the transfer. Alternatively, a user may manually transfer 312 money to and/or from the electronic money box (e.g., to a desired charity, etc.). Optionally, a user may take 314 the money out of the electronic money box (e.g., a charity collector, parent, etc.).

According to some embodiments, an electronic money box may include a mobile app and/or program designed for the charity collector that may be able to monitor the contents of the electronic money box and/or transfer money from the electronic money box and/or open and/or close the electronic money box and/or other controls.

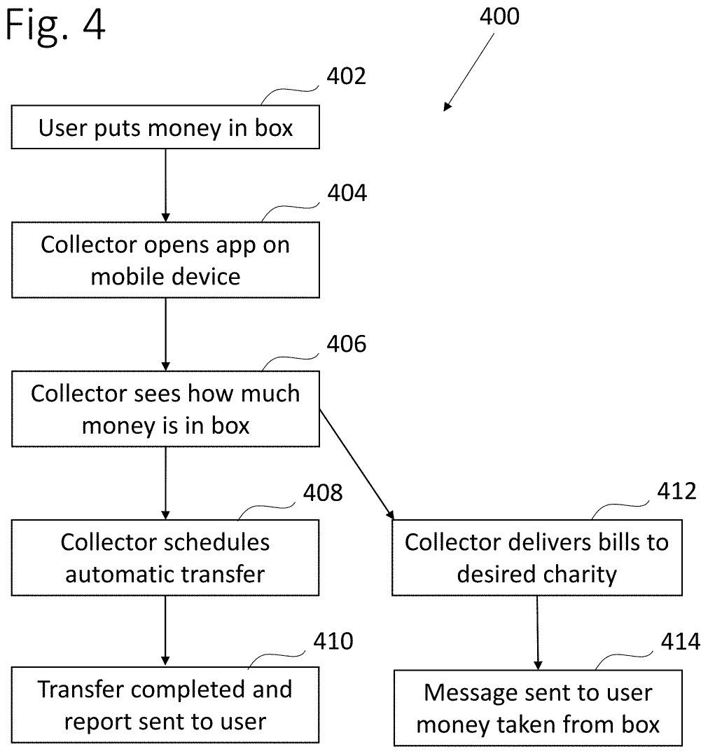

FIG. 4 is a flow chart illustrating a method 400 in accordance with an optional embodiment of the current invention. For example, a user may insert 402 money into an electronic money box. A charity collector may open 404 an app on their mobile device and be shown 406 how much money is in the electronic money box. The charity collector may then schedule 408 an automatic transfer, and when the transfer is complete, a text message may be sent 410 to the charily collector and/or user. Alternatively, a charity collector may schedule a visit to the charity box once the amount of money crosses a predetermined threshold. The charity collector may then manually retrieve the bills and delver 412 them to the desired charity. A text message may be sent 414 to the charily collector and/or user confirming receipt of the money by the charity.

According to some embodiments, an application may be able to show the charity collector the details of the contents of the box, and/or a charity collector may use the application to manually transfer the amount of money in the electronic money box a desired charity and/or person and/or account etc. Optionally, a charity collector may send a request to a user requesting that he send money and/or approve the collection of money. On approval, the charity collector may bill the credit card, etc.

According to some embodiments, once a user has transferred money, he may remove the money from the electronic money box and take it for himself. An application may store the credit card information of the user and/or allow the charity collector to transfer and/or collect money remotely. This may help that a charity collector may not need to physically visit the donor. Optionally, an electronic money box may be program and/or preset to give to a default charity and/or organization and/or account to which to transfer the money etc. Optionally, a user may change settings to whom he sends the money and/or the charity collector may then not be allowed to collect the money in the box. Optionally, a charity collector may program an automatic transfer scheduled at fixed time interval and/or he may schedule a single and/or multiple future transfers. Once a transfer and/or payment is made a user may receive a text message and/or email and/or notification. Optionally, a screen on the electronic money box may receive messages and/or pictures from a charity collector and/or various potential collectors. For example, a charity may send to the user pictures and/or a message about recent activity in the charity and/or may sent to the user's mobile application, etc. and/or the charity collector may send a request to the user that may appear on the electronic money box screen and/or on the app and/or mail of the user.

According to some embodiments, the electronic money box may include a function that requires a charity collector may come to a close proximity of the electronic money box and/or have a function to collect the finds with a mobile app.

According to some embodiments, a user may be able nullify collection and/or stop scheduled payments. Optionally, a user may set the program to give a certain budgeted amount of money to a charity collector and/or the program may alert the user when the budgeted amount has been reached and/or is close to reaching the budgeted amount.

### General

It is expected that during the life of a patent maturing from this application many relevant building technologies, artificial intelligence methodologies, computer user interfaces, image capture devices will be developed and the scope of the terms for design elements, analysis routines, user devices is intended to include all such new technologies a priori.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are Optionally, provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband/or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Data and/or program code may be accessed and/or shared over a network, for example the Internet. For example, data may be shared and/or accessed using a social network. A processor may include remote processing capabilities for example available over a network (e.g., the Internet). For example, resources may be accessed via cloud computing. The term “cloud computing” refers to the use of computational resources that are available remotely over a public network, such as the internet, and that may be provided for example at a low cost and/or on an hourly basis. Any virtual or physical computer that is in electronic communication with such a public network could potentially be available as a computational resource. To provide computational resources via the cloud network on a secure basis, computers that access the cloud network may employ standard security encryption protocols such as SSL and PGP, which are well known in the industry.

Some of the methods described herein are generally designed only for use by a computer, and may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. An electronic money box comprising:
a cash depository within a housing of the box including a money insertion slot leading from outside the housing into the cash depository;
a processor configured for
identifying cash deposits to the depository,
recording cash deposits and non-cash contributions,
reporting an amount of money in said depository, and
reporting an amount of money owed to a recipient of said cash contributions and said non-cash contributions;
a user input interface including a quick control for donating a predetermined non-cash contribution; and
an output interface configured to report to a user:
said cash deposits,
said non-cash contributions,
said amount of money in said depository and
said amount of money owed to a recipient of said cash contributions and said non-cash contributions.

2. The electronic money box of claim 1, further comprising a child proof system.

3. The electronic money box of claim 1, wherein the housing further comprises a network connection and wherein the processor is configured to execute and record a monetary transaction.

4. The electronic money box of claim 3, wherein the electronic money box is connected to at least one of a financial institution, a monetary account of a charity and a monetary account of an individual, through a network.

5. The electronic money box of claim 1, wherein said quick control includes a button.

6. The electronic money box of claim 5, wherein at least one control button is configured to provide at least one specific function.

7. The electronic money box of claim 1, wherein the processor is connected to a mobile application.

8. The electronic money box of claim 1, wherein said cash depository includes a locking mechanism.

9. A method for using an electronic money box, the method comprising:
depositing cash to the electronic money box by inserting money through a money slot into a depository;
depositing a predetermined non-cash deposit by activating a quick control;
recording said non-cash deposit in an electronic database.

10. The method of claim 9, further comprising recording said cash deposit in said electronic database.

11. The method of claim 10, further comprising reporting a value of said cash via a user input interface.

12. The method of claim 9 further comprising depositing a non-cash deposit by charging a credit card or financial mobile application.

13. The method of claim 9 further comprising depositing a non-cash deposit by inputting a user selected amount of money through a user input interface.

14. The method of claim 9 wherein said electronic money box includes a network interface and further comprising electronically transferring money to a recipient via said network interface and updating said electronic database in accordance with said money electronically transferred.

15. The method of claim 9, further comprising enabling said quick control by releasing a child proofing mechanism.

16. The method of claim 12, enabling said non-cash deposit by releasing a child proofing mechanism.

17. The method of claim 14, wherein the transferring occurs when a pre-determined threshold amount is reached.

18. The method of claim 9, further comprising confirming completion of transfer of the money to a recipient.

19. The method of claim 9, further comprising reporting to a recipient when a pre-determined threshold amount is reached.

20. The method of claim 9, further comprising collecting an amount of money from an electronic money box.
